(19) United States
(12) Patent Application Publication
(10) Pub. No.: US 2003/0231604 A1
(43) Pub. Date: Dec. 18, 2003

(54) System and method for configuring merchandise layout by way of mobile commerce

(76) Inventors: Fu-Yu Liu, Taipei (TW); Yi-Nan Li, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/308,811

(22) Filed: Dec. 2, 2002

(30) Foreign Application Priority Data
Jun. 13, 2002 (TW) 091112868

(51) Int. Cl. H04Q 7/00

(52) U.S. Cl. 370/313

(57) ABSTRACT

A system for configuring a layout of merchandise by way of mobile commerce includes a database server (101), a mobile commerce server (103) linked with the database server for generating business schedules, and at least one mobile terminal (109) linked with the mobile commerce server for downloading business schedules from the mobile commerce server and thereby assisting execution of commercial activities. Each mobile terminal includes: a business schedule storing module (301) for storing downloaded business schedules; and a merchandise displaying module (304) for recording and adjusting layouts of merchandise and sales assistance tools at storefront premises of various sellers. A related method includes the steps of: (a) downloading merchandise layout key information and commercial activities information; (b) displaying merchandise layout key information in the form of pictures; (c) recording a layout of merchandise and sales assistance tools; and (d) illustrating a merchandise layout adjustment advice.

### BACKGROUND OF THE INVENTION

1. Field of the Invention

The present invention relates to mobile commerce and systems and methods for arranging a layout of merchandise, and more particularly to a system and method that automatically facilitates adjustment of a layout of merchandise at a seller's premises.

2. Description of Related Art

In the retailing industry, layout of merchandise for viewing by customers is very important. If the merchandise are organized and identified according to groups of products, levels of quality, or usage, then the merchandise can be more effectively promoted to customers. It is more convenient for customers to select their desired merchandise.

Since the advent of wireless enterprise business applications, many companies are realizing the benefits of using small wireless hand-held mobile devices, which have emerged as an ideal mobile sales assistant. With the ability of such mobile devices to access a company's data system and the advantages of portability and low cost of ownership, mobile electronic commerce is becoming increasingly popular, and promise to change traditional business models. Small wireless hand-held mobile devices can strengthen technical support, make communication between enterprises and customers faster and more accurate, and thus yield more client satisfaction.

For example, U.S. Pat. No. 5,797,755 entitled Merchandise Display System and Method discloses a merchandise display system and method for related types of products. Each product is provided with a package bearing an icon indicating the type of product, its intended use, and an indication of its level of quality. A display arranges the product packages in rows and columns based upon the icon and indication of quality of each package. However, customer feedback cannot be obtained promptly. Adjustment of the layout of merchandise cannot keep pace with customers' changing purchasing habits.

### SUMMARY OF THE INVENTION

Accordingly, an object of the present invention to provide a system and method for configuring a layout of merchandise at a storefront premises by using a mobile terminal.

Another object of the present invention is to provide a method for configuring a layout of merchandise by way of mobile commerce which can ensure prompt adjustment of a desired quantity and arrangement of merchandise.

In one aspect of the present invention, a system for configuring a layout of merchandise by way of mobile commerce comprises a database server, a mobile commerce server linked with the database server for generating business schedules, and at least one mobile terminal linked with the mobile commerce server for downloading business schedules from the mobile commerce server and thereby assisting execution of commercial activities. Each mobile terminal comprises: a business schedule storing module for storing downloaded business schedules; and a merchandise displaying module for recording and adjusting layouts of merchandise and sales assistance tools at storefront premises of various sellers.

In another aspect of the present invention, a method for configuring a layout of merchandise by way of mobile commerce comprises the steps of: (a) downloading merchandise layout key information and commercial activities information; (b) displaying merchandise layout key information in the form of pictures; (c) recording a layout of merchandise and sales assistance tools; and (d) illustrating a merchandise layout adjustment advice.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic diagram of a system for configuring merchandise layout in accordance with a preferred embodiment of the present invention, the system comprising a database server, a mobile commerce server and at least one mobile terminal;

FIG. 2 is a schematic diagram of detailed infrastructure of the database server of the system of FIG. 1, and shows data communication between the database server, the mobile commerce server and one mobile terminal;

FIG. 3 is a schematic block diagram of function modules of one mobile terminal of the system of FIG. 1;

FIG. 4 is a flowchart of executing mobile commerce in accordance with a preferred embodiment of the present invention;

FIG. 5 is a flowchart of details of one step of FIG. 4, namely assisting execution of commercial activities; and

FIG. 6 is a flowchart of determining an optimized layout of merchandise for a client's storefront premises.

### DETAILED DESCRIPTION OF THE INVENTION

Reference will now be made to the drawings to describe the present invention in detail.

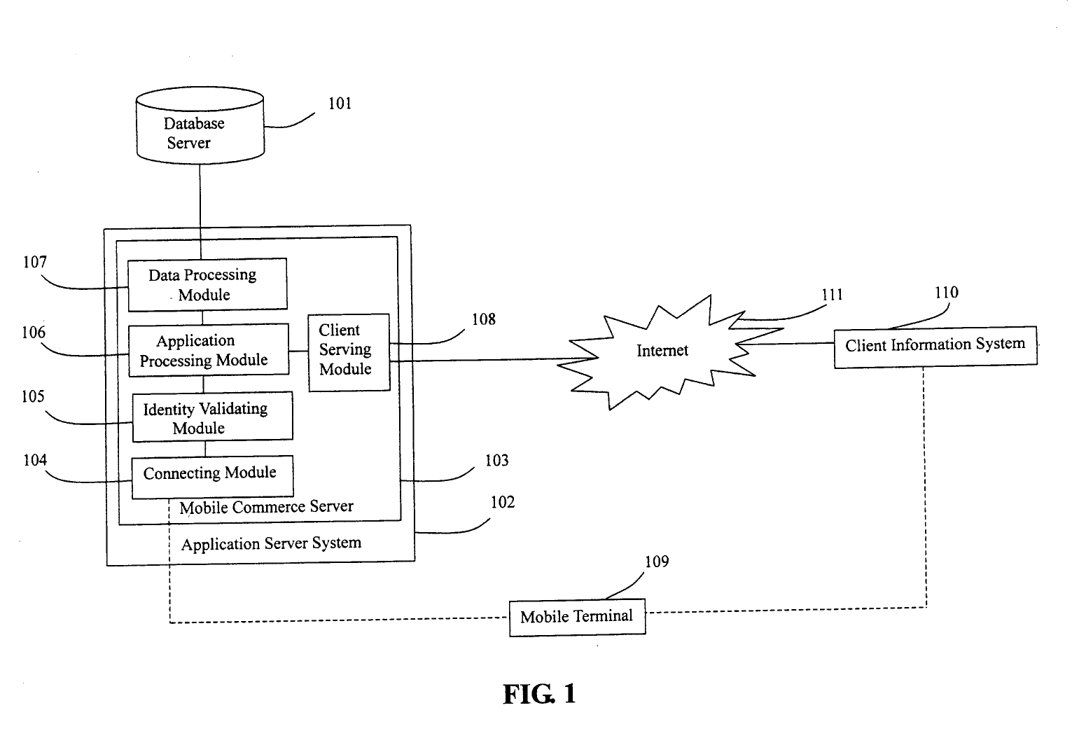

FIG. 1 is a schematic diagram of a system for configuring merchandise layout in accordance with a preferred embodiment of the present invention. The system for configuring merchandise layout comprises a three-tier information system. The three-tier information system comprises a database server 101 (the bottom tier), an application server system 102 (the middle tier), and a plurality of distributed terminal workstations 109 (the top tier, only one shown). The application server system 102 of the preferred embodiment comprises a mobile commerce server 103. Each terminal workstation 109 of the preferred embodiment is a mobile terminal 109, which can be a Personal Digital Assistant (PDA), a pocket personal computer (PC), a laptop computer, a palmtop computer, a smart phone or a notebook computer. A client information system 110 is connects with each of the mobile terminals 109 via a cable, infrared signals, or wireless communications. Each mobile terminal 109 connects with the mobile commerce server 103 via a cable, infrared signals, or wireless communications. The mobile commerce server 103 connects with the database server 101, and is used for generating business schedules in accordance with data stored in the database server 101. The mobile terminal 109 downloads a business schedule from the mobile commerce server 103, for assisting execution of commercial activities. The mobile terminal 109 shows steps of required commercial activities in accordance with the business schedule, records data on execution of commercial activities, and uploads data on transactions,and on execution of commercial activities for updating of data stored in the client information system 1 10.

The mobile commerce server 103 comprises a connecting module 104, an identity validating module 105, an application processing module 106, a data processing module 107, and a client serving module 108. The connecting module 104 connects with the mobile terminal 109, and is used for transferring data between the mobile terminal 109 and the mobile commerce server 103. The identity validating module 105 checks identities of personnel such as sales representatives, and distributes various business schedules to various sales representatives. The application processing module 106 generates business schedules for every sales representative in accordance with data stored in the database server 101, and updates data stored in the database server 101 in accordance with data sent from the mobile terminal 109. The data processing module 107 connects with the database server 101, and transfers data between the database server 101 and the mobile commerce server 103. The client serving module 108 connects with the client information system 110 via the Internet 111. The client serving module 108 sends information on mobile commerce to clients, and receives data on cooperating with clients and data on requirements of clients.

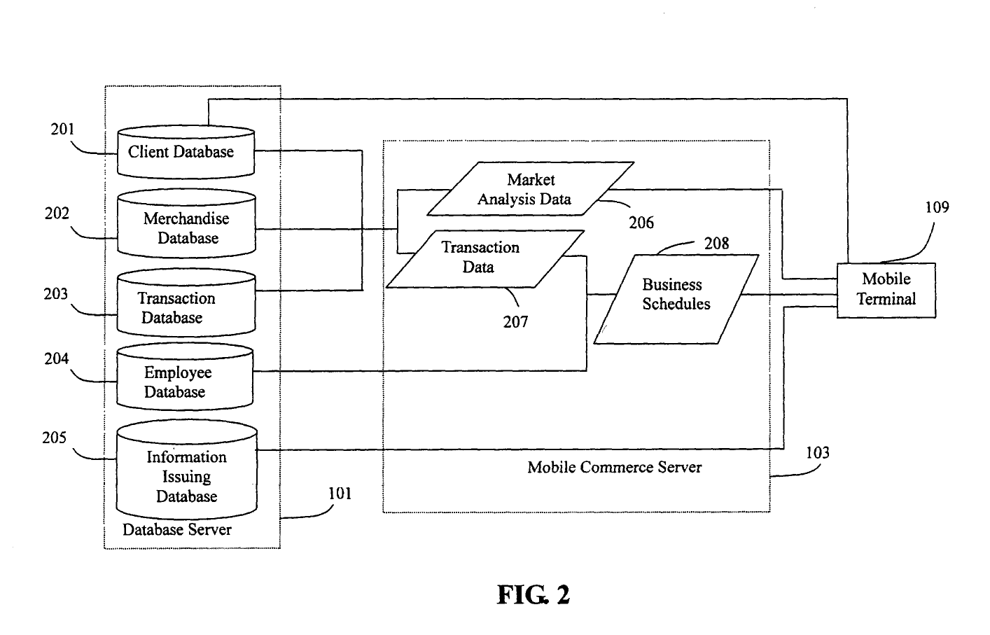

FIG. 2 is a schematic diagram of detailed infrastructure of the database server 101, and shows data communication between the database server 101, the mobile commerce server 103 and one mobile terminal 109. The database server 101 is a central database of an entire enterprise. The database server 101 comprises: a client database 201 for storing data on clients; a merchandise database 202 for storing data on merchandise sold by the enterprise; a transaction database 203 for storing transaction data on the enterprise; an employee database 204 for storing employee data including data on all sales representatives; and an information issuing database 205 for storing information issued by the enterprise. The application processing module 106 of the mobile commerce server 103 integrates data stored in the client database 201, data stored in the merchandise database 202, and data stored in the transaction database 203 to create transaction data 207 and market analysis data 206. The transaction data 207 and the market analysis data 206 are stored in the mobile commerce server 103. The transaction data 207 and data stored in the employee database 204 are processed by the application processing module 106 to generate business schedules 208 for sales representatives. The business schedules 208 are stored in the mobile commerce server 103. During the process of downloading data from the mobile commerce server 103, the business schedules 208, the market analysis data 206, data stored in the client database 201, and data stored in the information issuing database 205 are transferred to the mobile terminal 109 via the connecting module 104 of the mobile commerce server 103.

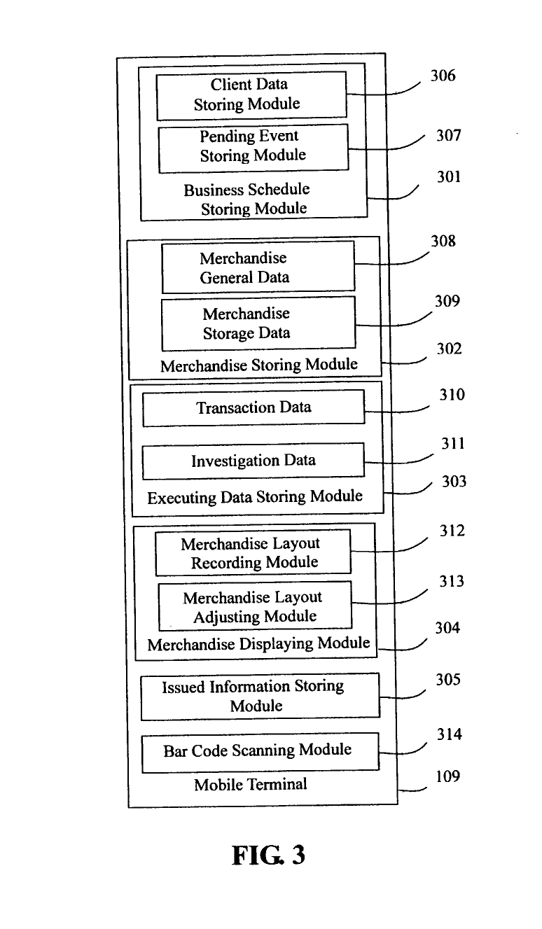

FIG. 3 is a schematic block diagram of function modules of one mobile terminal 109. The mobile terminal 109 comprises: a business schedule storing module 301 which is used to record work flow and clients that a sales representative visits; a merchandise storing module 302 which is used to store all merchandise information on the enterprise as a reference for the sales representative to inquire of; an executing data storing module 303 which is used to record data on execution of commercial activities; an issued information storing module 305 which is used to store information on the enterprise's current news, merchandise shortage notes, and newly promoted products; a bar code scanning module 314 which is used to scan and identify various clients' bar codes which respectively represent various clients; and a merchandise displaying module 304 which is used to record and adjust merchandise layouts at storefront premises of various clients.

The business schedule storing module 301 comprises a client data storing module 306, and a pending event storing module 307. The client data storing module 306 stores commercial activities information on clients, including client basic data such as name, address and phone number, client ordering data, and accounts receivable. The pending event storing module 307 is used to remind the sales representative of matters that need to be attended to. For instance, such matters may be orders that need conducting, collection of accounts receivable, and market investigation. The merchandise storing module 302 comprises merchandise general data 308 and merchandise storage data 309. The merchandise general data 308 includes basic merchandise data such as name, serial number and specification, merchandise price data and key merchandise data. The merchandise storage data 309 includes corresponding merchandise inventory volume and distribution information. The executing data storing module 303 stores transaction data 310 and investigation data 311. The information in the executing data storing module 303 is sent to the mobile commerce server 103, and is processed by the application processing module 106. The information in the database server 101 is updated accordingly. The merchandise displaying module 304 comprises a merchandise layout recording module 312 and a merchandise layout adjusting module 313. The merchandise layout recording module 312 is used for recording layouts of merchandise at storefront premises of various clients, and sales assistance tools. The merchandise layout adjusting module 313 is used for adjusting layouts of merchandise at storefront premises of various clients, and sales assistance tools. All data recorded by the mobile terminal 109 is subsequently uploaded to the database server 101 for storing.

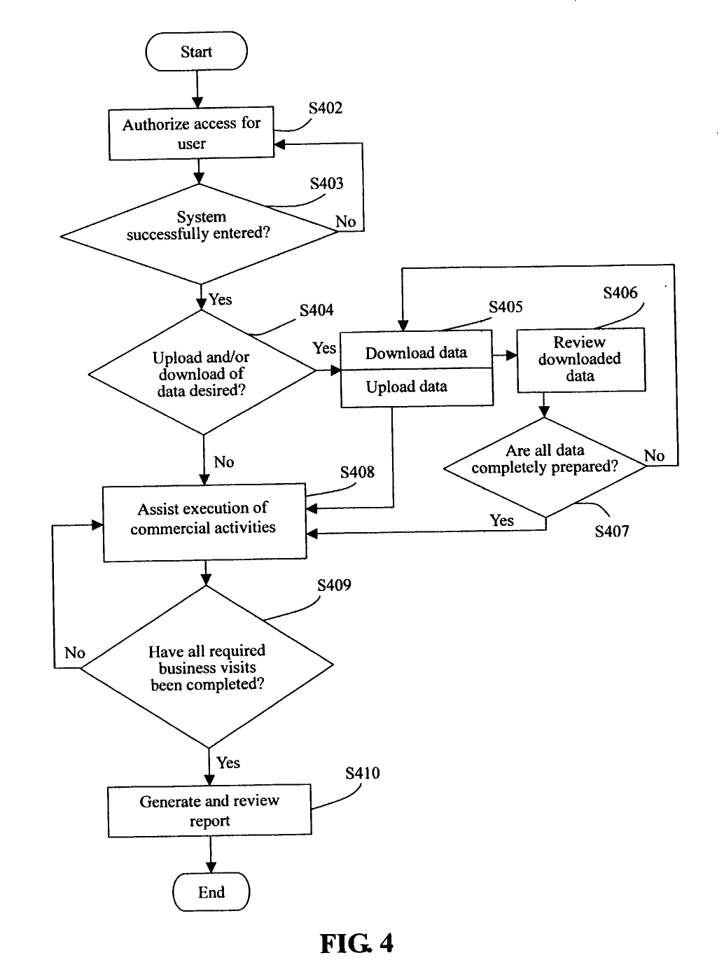

FIG. 4 is a flowchart of execution of mobile commerce in accordance with a preferred embodiment of the present invention. Firstly, in step S402, before a user enters the system, the mobile terminal 109 authorizes access for the user. In step S403, if the user cannot successfully enter the system, then the procedure returns to step S402. If the user successfully enters the system, then in step S404, the mobile terminal 109 inquires whether or not the user wants to upload and/or download data. If the user does not want to upload or download data, then the procedure proceeds directly to step S408 described below. Otherwise, in step S405, the mobile terminal 109 downloads data including a business schedule from the mobile commerce server 103, and/or uploads data on execution of commercial activities already completed to the executing data storing module 303 of the mobile commerce server 103. These download and upload operations can be performed individually and separately. If the mobile terminal 109 only uploads data, then the procedure proceeds directly to step S408 described below. If the mobile terminal 109 downloads data, then in step S406, when all the data have been downloaded, the mobile terminal 109 displays the downloaded data and a summary prepared by the user of items needed by the user for executing commercial activities. The user compares the downloaded data with the needed items, and marks any outstanding needed items. Then, in step S407, the business schedule storing module 301 determines whether all the downloaded data are prepared having regard to the user's mark, if any. If the downloaded data are not prepared, then the procedure returns to step S405, and the outstanding wanted data are downloaded. If the downloaded data are prepared, then the procedure proceeds directly to step S408. In step S408, the actual commercial activities are performed, and the executing data storing module 303 records corresponding operations during the process of execution of the commercial activities. When the commercial activities are finished, in step S409 the business schedule storing module 301 determines whether all required visits to clients have been completed. If all required client visits have not been completed, then the procedure returns to step S408 and the sales representative continues to visit other clients. If and when all required client visits have been completed, then in step S410, the executing data storing module 303 collects and analyzes all client visit information on the business schedule, and generates a consolidated report for the sales representative to review.

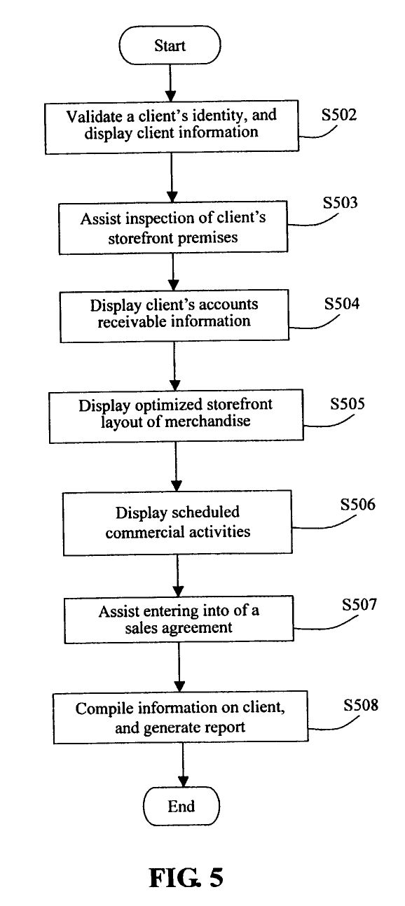

FIG. 5 is a flowchart of details of step S408 of FIG. 4, namely assisting execution of commercial activities. Firstly, in step S502 the mobile terminal 109 validates a client's identity, and displays corresponding client information. The client's identity can be validated by either scanning the client's bar code, or manually entering the client's name, code or other details. The client information includes basic information on the client.

In step S503, the mobile terminal 109 assists the user in inspecting the client's storefront premises. Matters examined may include verification of the enterprise's merchandise inventory, checking of the client's merchandise information, investigation of merchandise prices, investigation of fake products, and compiling of questionnaires. The executing data storing module 303 records the client visit and noteworthy matters arising from the visit. All this information is transferred to the mobile commerce server 103, so that the next business schedule can be arranged. In step S504, the business schedule storing module 301 displays the client's accounts receivable information, and reminds the sales representative to collect any outstanding payments. The application processing module 106 of the mobile server 103 computes a new optimized storefront layout of merchandise, based on the enterprise's sales strategy, the client's current storefront layout, the client's previous storefront layouts, and previous storefront layouts of other clients. In step S505, the new optimized storefront layout is stored in the business schedule storing module 301, and is shown on the mobile terminal 109. The new optimized storefront layout is used to guide the client to adjust its layout of merchandise at its storefront premises. In step S506, the business schedule storing module 301 displays the enterprise's scheduled commercial activities on the mobile terminal 109. Such scheduled activities are used to assist the client to make its own sales strategy.

In step S507, the mobile terminal 109 assists the sales representative to enter into a sales agreement with the client. Firstly, the executing data storing module 303 automatically creates a sales order in accordance with verified merchandise inventory information and a merchandise sales record of the client. The sales representative modifies the order in light of consultations with the client. When a final order is created, the mobile terminal 109 displays a notice advising whether the total price of the order is within the client's credit allowance. If the client wants to return merchandise, the executing data storing module 303 records data on returned merchandise.

Finally, in step S508 the executing data storing module 303 compiles information on the client, and generates a report on the client for the sales representative to check. All such information and the report are sent to the mobile commerce server 103, and processed by the application processing module 106. Subsequently, the processed information is transferred to the database server 101, and the application processing module 106 updates all data stored in corresponding databases.

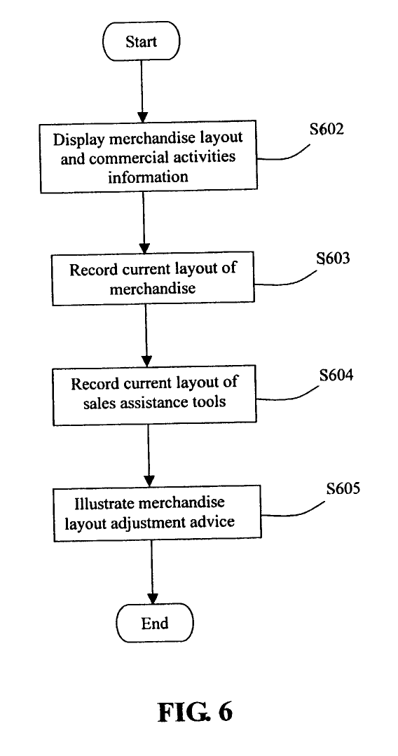

FIG. 6 is a flowchart of determining an optimized layout of merchandise for a client's storefront premises. Firstly, in step S602, the mobile terminal 109 displays merchandise layout key information and a client's commercial activities information downloaded from the database server 101 in the form of pictures, for the sales representative to preview. The merchandise layout key information includes merchandise layout regulations data, sales assistance tools data, and storefront layout data. In the preferred embodiment of the present invention, the merchandise layout regulations data is automatically input to the mobile terminal 109 on a daily basis. The commercial activities information includes activity name, activity specification, activity schedule, client code, and corresponding image file. In step S603, the mobile terminal 109 records data on a current layout of merchandise at the client's storefront premises. The data on a current layout of merchandise include client code, sales representative code, recording date, merchandise category, and merchandise quantity in the layout. In step S604, the mobile terminal 109 records data on a current layout of sales assistance tools at the client's storefront premises. The data on a current layout of sales assistance tools include client code, sales representative code, recording date, tool name, and tool position. Subsequently, the mobile terminal 109 transmits the recorded data to the database server 101 for analysis. Finally, in step S605 the mobile terminal 109 illustrates a merchandise layout adjustment advice for the sales representative to review.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for configuring merchandise layout by way of mobile commerce, the system comprising:
a database server;
a mobile commerce server electronically linked with the database server for creating business visit schedules; and
at least one mobile terminal electronically linked with the mobile commerce server for downloading the business visit schedules from the mobile commerce server, the at least one mobile terminal comprising:
a business schedule storing module for storing the downloaded business visit schedules and for assisting arrangement of business visit schedules; and
a merchandise displaying module for recording and adjusting layouts of merchandise and sales assistance tools.

2. The system for configuring merchandise layout by way of mobile commerce as claimed in claim 1, wherein the merchandise displaying module comprises a merchandise layout recording module for recording layouts of merchandise and sales assistance tools, and a merchandise layout adjusting module for adjusting layouts of merchandise and sales assistance tools.

3. The system for configuring merchandise layout by way of mobile commerce as claimed in claim 1, wherein the at least one mobile terminal further comprises a bar code scanning module for identifying bar codes of clients.

4. A method for configuring merchandise layout by way of mobile commerce, the method comprising the steps of:
(a) downloading merchandise layout key information and commercial activities information;
(b) displaying merchandise layout key information in the form of one or more pictures;
(c) recording a layout of merchandise and sales assistance tools; and
(d) illustrating a merchandise layout adjustment advice.

5. The method for configuring merchandise layout by way of mobile commerce as claimed in claim 4, wherein the merchandise layout key information and commercial activities information are downloaded from a database server.

6. The method for configuring merchandise layout by way of mobile commerce as claimed in claim 4, wherein the merchandise layout key information includes merchandise layout regulations data, sales assistance tools data and storefront layout data.

7. The method for configuring merchandise layout by way of mobile commerce as claimed in claim 6, wherein the merchandise layout regulations data is automatically input to the mobile terminal on a daily basis.

8. The method for configuring merchandise layout by way of mobile commerce as claimed in claim 4, wherein the commercial activities information includes activity name, activity specification, activity schedule, client code, and corresponding image file.

9. The method for configuring merchandise layout by way of mobile commerce as claimed in claim 4, wherein the layout of merchandise includes data on client code, sales representative code, merchandise name, recording date, merchandise category, and merchandise quantity in the layout.

10. The method for configuring merchandise layout by way of mobile commerce as claimed in claim 4, wherein the layout of sales assistance tools includes data on client code, sales representative code, recording date, tool name, and tool position.

11. The method for configuring merchandise layout by way of mobile commerce as claimed in claim 4, further comprising the step of:
transmitting a layout of merchandise and sales assistance tools to a database server for storing.

12. A method of configuring merchandise layout via mobile commerce for a sales representative when said sales representative visits a display site of a client, comprising:
providing a database including information of display arrangement of different products in different rows and columns of different type display panels and those of commercial activities of said products;
downloading, from said database, merchandise layout key information and the commercial activities of the products;
uploading, from a mobile terminal carried by the sales representative, a layout of merchandise on the display site of said client; and
adjusting the layout of merchandise on the display site of the client according to the commercial activities, the merchandise layout key information and the compared information of display arrangement of the products stored in the database so as to achieve an optimal sales result.
